(19) United States
(12) Patent Application Publication
(10) Pub. No.: US 2008/0230477 A1
(43) Pub. Date: Sep. 25, 2008

(54) Blast energy accumulator and energy conversion device and method

(76) Inventors: Gueorgui Milev Mihaylov, Virginia Beach, VA (US); Kirollos S. Kirollos, Virginia Beach, VA (US)

Correspondence Address: Bradley D. Goldizen, One Columbus Center, Ste. 665, Virginia Beach, VA, 23462, US

(21) Appl. No.: 11/888,192

(22) Filed: Jul. 31, 2007

Related U.S. Application Data
(60) Provisional application No. 60/834,023, filed on Jul. 31, 2006.

(51) Int. Cl. C02F 1/44; F42D 3/00; B01D 29/60; B01D 15/10; B01D 61/10; B01D 61/20

(52) U.S. Cl. 210/652; 102/301; 210/251; 210/198.2; 210/137

(57) ABSTRACT

An energy accumulator includes a blast chamber, an explosive charge and a detonator that explodes the charge within the blast chamber. A piston forms part of the blast chamber and connects to an energy accumulator or potential energy storage device such as a spring. When an explosive charge is detonated, the piston is forced away from the blast chamber. Energy from the displacement of the piston is captured in the energy accumulator. The energy accumulator forces a fluid through different devices requiring high pressure such as desalinators, ultra and micro filters or chromatographs.

The present invention relates to U.S. Provisional Patent Ser. No. 60/834,023 filed on Jul. 31, 2006 and claims priority therefrom.

The subject matter of this application did not receive federal research and development funding.

### FIELD OF INVENTION

The present invention generally relates to a method and device for the accumulation and harnessing of energy produced by detonation of an explosive material that creates a high energy blast wave. The energy is subsequently employed to do work or converted into potential energy for later use. More particularly, the present invention relates to portable equipment that requires high levels of energy to operate. Further, the present invention relates to a method used for portable equipment for purification and separation of fluids, and desalination of water by a reverse osmosis process and a device driven by pressure generated from a compact and powerful source using energy created from an explosion and that also allows energy recovery.

### BACKGROUND OF INVENTION

The main obstacle in developing and constructing lightweight portable equipment that requires high energy to operate is the limitation of incorporating a small compact and high efficient energy source. Batteries are one source that may be used to provide an energy source for portable equipment. The state of the art of batteries has greatly advanced in the development of compact and high efficiency batteries. However, a battery capable of producing enough power to generate 80 bars of pressure or 1,160 psi typically necessary for performing filtration tasks is not portable and is mobile only when loaded onto a truck. One of the many examples of portable equipment that requires high-energy power sources are fluid purification devices such as water purification and desalination equipment. It is well known from the existing art that the purification and filtration of fluids by reverse osmosis requires the use of high pressures usually by means of a high-pressure pump. There are many successfully designed units for desalination coupled with high-pressure pumps. Some of these prior art devices claim to be portable; however these systems require special transportation units.

To avoid using a heavy source of energy and pump, other hand-driven devices have been proposed. Most of these hand-operated devices are designed to optimize the energy spent during the filtration process. Thus, many of these devices include designs that are made with valves arranged within a system for allowing filtered water to recuperate part of the energy spent. Various hand-driven mechanisms are used for movement of the pump's plunger necessary for the filtration process.

Anderson, U.S. Pat. No. 6,383,384, suggests a crank driven shaft with moving thread. The system works when the water to be filtered comprises only a comparably very low salinity level, such as on the surface of lakes or rivers or well water. At higher levels of salinity, the required pressure necessary to perform the filtration process prohibits rotation of the crank. Thus, the Anderson device is impractical for use with water including high salinity levels. Other hand-held reverse osmosis apparatuses require powerful cranking efforts to provide the requisite energy for effectuating the water purification process.

Miers, U.S. Pat. No. 5,531,887, discloses a manually operated reverse osmosis desalination system using semi-permeable membranes to selectively purify an aqueous fed solution. A reciprocating piston or diaphragm pump provides the pressure to drive the solution through the membrane thereby continuously flush the membrane surface. Another example of the application of reverse osmosis technology known in the art is disclosed by Tempest, U.S. Pat. No. 5,741,416, wherein a booster pump is used to enable the removal of salt and finely divided particles from an aqueous solution.

Keefer, U.S. Pat. No. 4,288,326, discloses another development of a reverse osmosis system. Keffer's apparatus for desalination uses a combination of pump action and a low speed rotary shaft that selectively permeates purified water from a pressurized feed solution through a semi-permeable membrane. The piston means of Keefer includes a spring-loading means to afford double acting and reciprocating piston action.

Herrington et al, U.S. Patent Publication No. 2004/0173528 A1, discloses another development of the filtration process. In Herrington the device includes a leverage driven mechanism that moves a plunger into water, displacing part of it, and providing the necessary operating pressure for filtration. The pump works with seawater but has a very low productivity due to the amount of energy required for operation.

Some of the existing art aims to purify and/or filtrate water including high salinity water through the use of various hand-driven pumps. Despite of energy saving designs all of the prior art fails to provide the requisite amount of power needed to filtrate a required amount of water within a reasonable time period to effectively operate as a hand-held survival water filtration and desalinization unit. The present application and invention aims to solve this problem.

Historically, guns have utilized powder charges to generate powerful forces to propel bullets through a barrel and downrange to great distances. Recently the fastening technology for buildings widely uses the power of combustion of gunpowder in a .22 caliber through .27 caliber to drive pins into concrete, rock and other hard surfaces. The art of nailing and striking uses combustion of propane, butane, natural gas, other gas mixtures or small charges of gunpowder.

Ohtsu et al., U.S. Pat. No. 4,773,58, and Thieleke et al., U.S. Pat. Nos. 6,443,118 and 4,665,868, are designated for use as fasteners or nailers in the construction industry. Nakazato et al., U.S. Pat. No. 4,075,850, is designed as striking tool. Common in the above designs is the use of gas combustion to create a concentrated power impulse in a very small space to drive a fastener. The use of gunpowder leads to even smaller volumes in which the power impulse is generated. Haytayan, U.S. Pat. No. 4,821,938, and Gassner et al., U.S. Pat. Nos. 4,741,467 and 6,059,162, use gunpowder charges for fasteners and/or nailers.

All of the above noted art has application in striking/nailing tools due to the generically inherited properties of explosion-based mechanisms to direct extremely high power impulses lasting only milliseconds over a small surface area to disturb the material structure by inserting a nail or making hole into which a fastener may be inserted. In all above cited literature there is no art providing the use of impulse of combustion or gunpowder for rotation, slow moving mechanisms or alike. Moreover, none of the cited prior art includes an energy accumulator that may be utilized to produce a filtered fluid. Notwithstanding these and related developments in the art, there appears to be no apparatus which provides an efficient means for creating, storing, and utilizing energy to provide a driving force prerequisite for sustaining a reverse osmosis apparatus. Likewise, none of the art includes a methodology for water purification purposes as well as for other apparatus requiring portable high energy source. Such an apparatus may include pumps for micro-filtration but is not limited to pumps for high pressure liquid chromatography (HPLC) and pumps for pressure generators for gas chromatography (GC).

### SUMMARY OF THE INVENTION

The device is preferably an energy accumulator that comprises a detonation chamber having a piston arranged therein. The piston forms part of the detonation chamber such that when an explosive charge is detonated within the detonation chamber, the piston is forced away from the remaining parts of the detonation chamber. Displacement of the piston compresses a spring or other mechanical energy accumulating device. Simultaneously, the piston may be used to draw in a fluid-to-be-filtered into the device. Potential energy from the mechanical energy accumulating device may then be released to create a unidirectional, high-pressure force that is applied to the fluid-to-be-filtered and forcing it through a filter media.

The main goal of the present invention is to transfer and/or convert the potential energy accumulated from a detonation or blast that is stored in the accumulator means to mechanical energy such as a high-pressure driving force and/or electrical energy and/or thermal energy.

Another goal of the present invention is to provide a methodology to build small yet very effective portable and hand-held fluid purifier and/or desalination devices. Yet another goal of the present invention is to build a portable desalinization device based on a blast produced by a charge of gunpowder or blast created by detonation of gas air mixture.

Another goal of the present invention is to transform saline water into clean drinking water through the use of the chemical energy that is created in a controlled explosion.

In agreement with the set forth objectives, the present invention is based on a methodology comprising several steps for realizing a method and device for filtering fluids and/or performing water purification and/or desalinization of fluids. The following are a listing of the steps to be performed during the filtration process. It should be noted that these are the optimal steps for performing the preferred embodiment of the invention. Some of these steps may be performed in different sequential manners or with less than those of the preferred embodiment of the invention without deviating the scope of the invention.

First, power is created from a controlled detonation, explosion or blast driven by a gas combustion step or ignition of gunpowder step. This step creates a substantial amount of energy for an extremely short time period. Second, the energy created from the detonation is accumulated to create a stored potential energy power in an appropriate means such as a loaded spring, compressed air or other gas. Third, the process of accumulating or storing the potential energy includes cocking the accumulated energy by a mechanical locking mechanism for later release.

Fourth, the accumulated energy is released in a slower mode than that of the energy accumulation step that created energy by the controlled explosion to develop a necessary pressure to actuate an appropriate mechanism to convert the high level potential energy to dynamic energy that exerts pressure via a piston of a high-pressure pump, and/or to convert the high level potential electric energy and/or thermal energy. In a case of producing dynamic energy, a piston of a high-pressure pump pushes water through a flow restrictor allowing a relatively slow flow of water and/or fluids to gradually increase the pressure over a reverse osmosis membrane. In the case of electrical and thermal energies, state of the art and available mechanisms convert the accumulated energy to desired states for performing work.

In a case of the blast actuated fluids and/or water purifier and/or desalinator, allowing the rejected fluid and/or water having increased impurity and/or salinity to feed back the high-pressure pump acting on the back of the high-pressure plunger to further create pressure. Synchronizing the activation of all valves keeps needed working pressure throughout all cycles of the process to further conserve energy and to assist the process of pressurizing and subsequently purifying and/or filtrating the feed fluid and/or saline water. In order to charge the reverse osmosis unit with pressure without sufficient deviations, a special low space reducing valve-buffer is used.

In the preferred embodiments, the present invention utilizes two main sources of energy. The first source of energy is a loaded charge of gunpowder which is detonated via a firing pin or the like. The second is a combustive gaseous mixture that is ignited via a spark plug or other electronic igniter. The combustive gaseous mixture may comprise an aerosol dispersed fuel. Either embodiment may comprise, one or more of the two main energy accumulating devices. The first energy accumulating device is based on a spring loading and the second is based on compressing air or other gas by a system that includes a cylinder piston or system utilizing a liquid plunger with or without a phase separation. The phase separation may be recognized with or without direct contact between the liquid used and the compressed gas.

A combination of either of the two approaches depends on the particular goals and additional development of those arts, aiming for small space, light construction, low cost, place of use, intended use with one supply, etc. The combination of a gunpowder blast and energy accumulator comprising a crest-to-crest spring or telescopic spring can be used for purifying mainly high concentrated solutions. The combination of gas-combustion blast with a gas or an air spring is suitable in general for medium to high concentrations. A combination of gas-combustion blast with an air spring designed directly over the saline solution is more appropriate for surface waters. This type of device can be very productive in filtering a fluid over a short time frame and results in light construction with high desalination capacity.

The present invention suggests the use of a modular approach, which is distinguishing all the parts by their main function, but some modules can be combined in one, and all of them can be integrated into a single body.

The present invention utilizes a state of the art reverse osmosis membrane and valves acting in a manner to conserve the energy used in the process. The use of harnessing the energy produced by a powerful blast to charge the energy accumulator and then to use and/or convert this stored energy, for example to purify fluids and/or water by reverse osmosis, allows the building of a very compact and portable device that requires high energy to operate. These devices include desalinating devices, known as desalinators, which are extremely important as part of the survival equipment in the sea and expected regions with high salinity of the surface waters.

The power generated from a blast can be stored into the energy accumulating means and then released to actuate a portable apparatus requiring high-energy consumption. Such an apparatus can be, for example portable HPLC's and portable GC's. Both of them require high-pressure fluid sources. A high-pressure pump for a HPLC requires pressure of 30 to over 200 bars at a comparably low flow rate of 1 to 5 cc/min. consumption to operate. This pressure and flow rate can be obtained by a powder actuated and energy accumulating mechanism. A flow equalization and/or other means allows work to be performed at a moderately fluctuating flow when interrupted by a blast. Flow equalization is another objective of the present invention.

According to the objectives set forth hereinafter, the blast energy accumulator and conversion device of the present invention comprises the following parts. It should be noted that the parts may be combined into single units that perform the same functions as set forth above to practice the invention. Moreover, it may be recognized that these parts may be substituted for others or the invention may be modified to delete certain elements listed below without deviating from the scope of the invention. The parts include a blast actuating or detonation chamber that receives an explosive charge of combustible gas or charge of gun-powder to generate a controlled explosion, detonation or blast. A power accumulating means is configured with a moving part such as a piston that is forced away from the detonation chamber to load a fast acting spring. The spring may be provided in various forms and of different types including, but not limited to, metal, plastic, and gas. A catch or cocking mechanism retains the spring in a loaded state. A releasing mechanism is actuated to release the potential energy stored in the loaded spring. The releasing mechanism can be combined with the catch or cocking mechanism. An energy consumer and/or converter; in case of fluids and or water purifier, a high pressurizing pump for driving the fluid through a means of purification or an analytical means. All of the above elements can be defined as a blast of energy accumulating means. The blast of energy accumulating means can be used further for driving an energy source in different high energy requiring consumers, requiring some other more specific means.

In the case of fluids and/or water purifier, a flow restrictor is included and allows a gradual increase of the pressure in a reverse osmosis chamber. The reverse osmosis chamber comprises a reverse osmosis membrane separating the chamber into two spaces; one chamber includes saline water and the other contains desalinated water. Otherwise the device may comprise a micro-filtration chamber with particulates pre-filter and a fine micro-filter separating the chamber in two spaces. One space includes rejected fluid having a higher amount of contaminates that when it first entered the device and filtrated fluid. A plurality of pressure actuated valves allows the reject saline water or other fluid to assist the plunger into the high-pressure pump, and to assist valve actuation. All of the elements needed to provide high pressure at moderate fluctuation of the fluid flow to drive fluid through a chromatographic means. These elements may include an injector, a column, and a detector. Means to equilibrate the flow fluctuation and/or provide methodology and means for chromatographic process in a field condition may be included.

A main objective of the present invention is to transfer and accumulate short powerful blast impulses generated by combustion or gunpowder explosions into an appropriate energy accumulating or storage means.

Another objective of the present invention is to transfer and/or convert potential energy accumulated from the blast in the accumulator or storage means to mechanical energy to create a high-pressure driving force and/or electrical energy and/or thermal energy.

Another objective of the present invention is to provide a methodology to build a small, yet very effective portable, hand-held fluid purifier and/or desalination device. To that end, another objective of the present invention is to build portable desalinator based on gunpowder load blast or gas-combustion blast.

Another objective of the present invention is to transfer potential energy from the accumulating or storage means to a driving force that creates a high pressure necessary for effectively achieving reverse osmosis on a scale of production that supports the survival of a user.

Another objective of the present invention is to provide a reverse osmosis apparatus for use without hand-actuated power provided by the operator.

Yet another objective of the present invention is to build an energy accumulator that can be connected to different energy consumers such as high-pressure pumps for HPLC or pressure generators for GC carrier gas.

Yet another objective of the present invention is to provide a methodology for effective portable chromatographic units working properly even in a fluctuating flow. A consecutive objective of the present invention is to set up a methodology and an appropriate device allowing work with moderately fluctuating flow.

The above and further objects, details and advantages of the invention will become apparent from the following detailed description, when read in conjunction with the accompanying drawings.

### BRIEF DESCRIPTION OF THE DRAWINGS

The present invention is illustrated by the following schematics and drawings using an example a fluids and/or water purifier.

FIG. 1 shows a general block-schematic of a desalinating reverse osmosis (RO) device using an explosion or a blast power.

FIG. 2 represents a schematic diagram of a desalinating RO device using a gunpowder charge to generate an operating force.

FIG. 3 represents a schematic diagram of a desalinating RO device using a gas-combustion chamber as a power source for generating an operating force.

FIG. 4 shows a more detailed schematic diagram of a gunpowder powered device for use in RO using a telescopic spring as an energy accumulator connected to auxiliary devices as part of the entire purification system.

FIGS. 5A-5C shows an integrated design of a gunpowder powered device using a telescopic spring as an energy accumulator in three stages of action, FIG. 5A—an initial state, FIG. 5B—a power stroke, and FIG. 5C—a back strike and purification process state.

FIG. 6 depicts a more detailed cross section diagram of a gunpowder actuated device in which other auxiliary devices are integrated in the same body.

FIG. 7 depicts a more detailed cross section diagram of an integrated gas combustion powered device for RO using a crest-to-crest spring as an energy accumulator.

FIG. 8 shows cross section view of a RO device using disc springs, commonly known as Belleville springs, as an energy accumulator.

FIG. 9 represents cross section view of a RO device based on gunpowder actuation and compressed gas spring as an energy accumulator.

FIG. 10 shows a cross section view of a gas combustion actuated device for RO using a crest-to-crest or a wave spring as an energy accumulator.

FIG. 11 shows a cross section diagram of one partial embodiment of a powder actuated micro-filtration unit.

FIG. 12 represents a powder actuated high-pressure pump for HPLC.

FIG. 13 represents a schematic diagram of a portable HPLC system using a gunpowder actuated pump.

FIG. 14 shows a three dimensional schematic diagram of an on-line device for flow indexation (Indexing) in a portable HPLC.

### LIST OF REFERRED NUMERALS

100—Blast actuated —energy consuming assembly
102—Cylindrical Body of desalinator
110—Explosion chamber assembly
112—Gun-powder explosion chamber or detonation chamber
121—Firing pin assembly or detonator
122—Gun-powder load or charge
124—Powder propelled plunger or piston
125—Powder plunger stem or piston rod
126—Piston Bore
140—Gas-combustion chamber assembly
141—Spark plug or detonator
142—Air inlet
143—Fuel inlet
144—Piston of gas-combustion chamber
145—Stem of gas combustion plunger or piston rod
160—Energy accumulator
162—Energy accumulating spring
163—Locking (cocking/releasing) assembly
164—Spring holding cylinder (cup)
166—Gas-spring accumulator
168—Gas compressing plunger or piston
169—Gas compressed plunger or piston
170—Reversing spring or resetting spring
180—High pressure pump
181—High liquid pressure plunger or piston
182—High pressure cylindrical chamber
183—High pressure spring moved stem or connecting rod
184—Salt water inlet
185—Piston assisting inlet/outlet
200—Pressure regulator
202—Pressure regulating hydrodynamic resistance-flow restrictor
204—Pressure restricting orifice
300—RO chamber
302—RO membrane
310—Outlet for desalinated water
312—Outlet for the saline water
401—Outlet desalinated water-regulating valve
402—Saline water intake/expel regulating valve
403—High pressure water lines
404—Feed back regulating valve
420—Pre filtration media
422—Micro filtration media
424—Micro filtration media support
500—Liquid chromatographic system
501—Compressed gas metal cylinder
504—Liquid reservoir
505—High-pressure powder actuated HPLC pump
506—Fluid inlet
507—Fluid outlet
510—Filter
512—Back pressure regulator
514—Pressure transducer
516—Injector valve
520—HPLC column
530—Flow indexer
531—Indexer body
534—Flow path
536—Rotor obstructer
537—Marking fluid inlet
538—Step motor
540—Detector
550—CPU-integrator
560—LCD
570—Printer

### DETAILED DESCRIPTION OF THE DRAWINGS

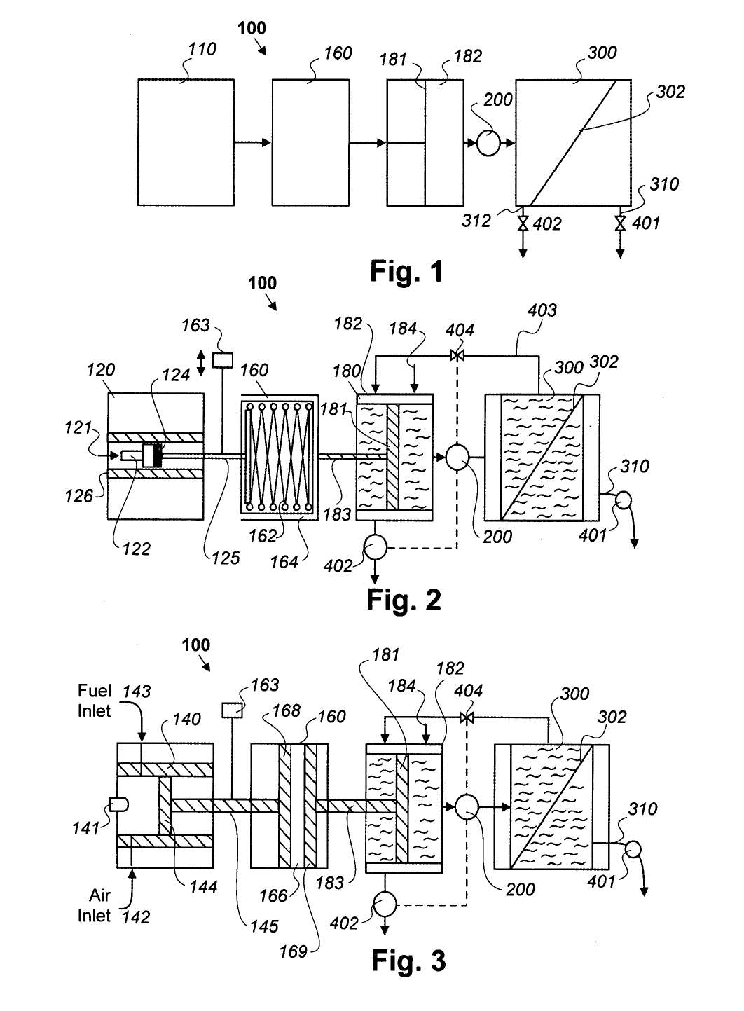

Now referring to FIG. 1, a generic block schematic diagram shows the interaction between the main components of the present invention, purifier and/or desalinator 100. A gunpowder charge, or explosive gaseous mixture, that creates a powerful energy impulse within a very short time period is deposited into explosion or detonation chamber 110. The energy impulse, which is created in the detonation chamber, is converted by mechanical means into a unidirectional mechanical force. In the energy accumulator 160, this unidirectional mechanical force acts on a pneumatic or mechanical spring loading of the spring to lock it in loaded position for storing potential energy. When the loaded spring is released, force is transferred by a mechanical means to a high-pressure plunger 181. Plunger 181 presses the fluids and/or water to be filtered through a pressure regulator 200 into one side of a filtration module and/or RO membrane 302 in an RO chamber 300. The clean fluid and/or water, after passing through the RO membrane 302, is drained through outlet 310 and valve 401 and the fluid and/or water with increased impurity and or salinity through outlet 312 and valve 402.

FIG. 2 shows a similar device to that of FIG. 1, which has a detonation chamber 120 charged with a gunpowder load or charge 122. A hammer represented by arrow 121 strikes a rear end of the explosive charge causing a controlled detonation of the gunpowder charge 122 within the detonation chamber 120. The detonation chamber 120 includes a bore 126 into which a piston 124 is arranged. Piston 124 is arranged at a front end of the gunpowder charge. Hot gases are created by the detonation of the gunpowder load 122. These gases expand into the bore 126 and onto a face of the piston 124 which has a rod 125 that extends into energy accumulator 160 for transferring kinetic energy from the piston 124 thereto. In the energy accumulator 160, the rod 125 pushes against spring 162 causing it to become compressed and loaded with potential energy. The spring 162 is locked in this loaded state by lock 163. The spring 162 is chosen as one of group including crest-to-crest design, telescopic designed spring, conical spring, regular cylindrical spring, or gas compression spring comprising another plunger and cylinder. The energy of the explosion blast then is accumulated in the spring 162. Unlocking the spring 162, the spring pushes spring holding cup 164 that connected to connecting rod 183. This connecting rod exerts pressure against piston 181 arranged in a high-pressure pump 180. In a loaded spring position, chamber 182 of pump 180 is filled with impure fluids and/or salt water drawn in from the inlet 184. By pressurizing the impure fluids and/or salt water in chamber 182 through the pressure regulator 200 and high pressure line 403 the impure fluids and/or salt water starts to develop pressure over the filtration module and/or RO membrane 302 in the RO chamber 300. The cleaned fluids and/or water is ducted to outlet 310 through valve 401, and the fluids and/or water with increased impurity and/or salinity move through feed back valve 404 to high pressure pump 180 to assist in the process to save energy by pushing against the back of piston 181 and then through the regulating valve 402 to be expelled out.

FIG. 3 shows another embodiment similar to the generic embodiment shown in FIG. 1. In this embodiment, the device includes a controlled explosion chamber 140 designed for use with a combustible gaseous mixture in a confined air space with an adjustable volume. Initially, the chamber 140 is filled with air by inlet 142 and a gas such as propane, butane, and their mixture or light fractions of gasoline or other such fuel that is atomized and fed into the chamber fuel inlet 143. After ignition by the spark plug 141, the high pressure hot gases press against and displace the chamber piston 144 and piston rod 145. Kinetic energy is transferred from to the spring 162 in the energy accumulator 160. In this particular embodiment, the spring demonstrated is a type of compressed gas or air spring arranged within a chamber 166. Piston 168 is compressing the gas into chamber 166 and forcing piston 169 to move away from it. When pressure in the chamber 166 is maximum, the spring locking assembly 163 locks the gas/air spring. The increased pressure pushes the piston 169 adjacent to rod 183 thus pressurizing the impure fluids and/or saline water by way of piston 181. A flow restrictor 200 maintains the flow to prohibit fluid-to-be-filter from entering the chamber too rapidly or with too much force to protect a reverse osmosis chamber 300 and RO membrane 302 from damage. Filtrated fluid which has passed through membrane 302 is expelled through outlet 310 and regulating valve 401. The purpose of the valve is to maintain optimal pressure difference between both sides of membrane 302. The fluid with increased salinity transferred by valve 404 helps to regulate energy by saving and feeding back flow pressure onto the back side of the high-pressure piston 181. Afterward, this fluid is expelled by intake/expel regulating valve 402.

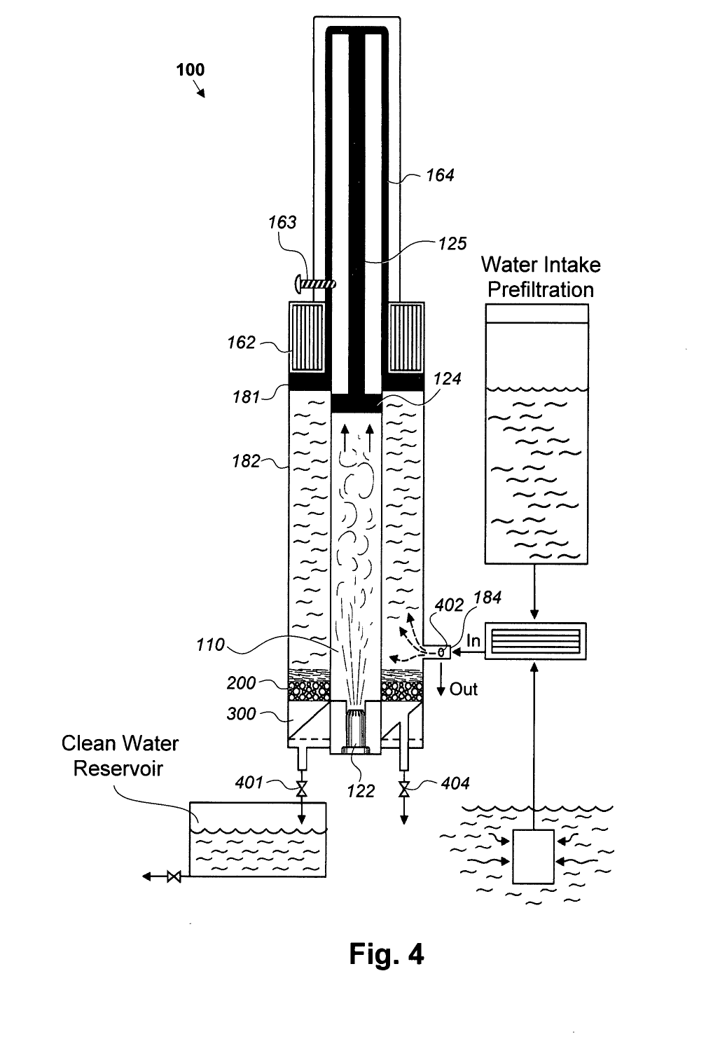

FIG. 4 depicts a cross section diagram of a desalinator of the present invention in which all main parts are integrated in a single unitary body 100. The energy accumulating device is utilized in providing a desalinator which is shown interacting with some auxiliary elements of the desalinating system. As far as all of the auxiliary elements are, only for better understanding of functionality they are not numbered. The saline water after some pre-filtration is feed to the desalinator by a salt-water inlet 184. After the explosion and power stroke, the intake/expel regulating valve 402 blocks the intake and the saline water is forced to the reverse osmosis chamber 300 passing fluid pressure regulator 200, which can comprise several layers of staggered filter media. Further, the work of the desalinator is similar to what has already been described in previous embodiments, not including details, which are not subject of the present invention.

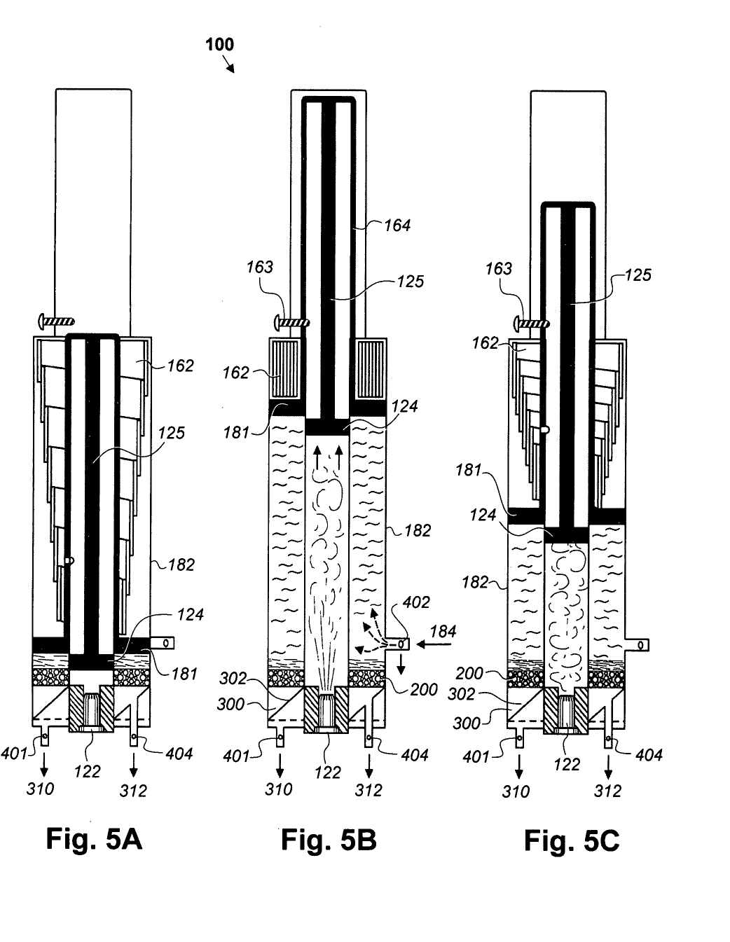

FIGS. 5A-5C shows three stages of the explosion driven desalinator depicted in FIG. 4. FIG. 5A shows the desalinator with energy accumulating telescoping spring 162 fully opened when the spring is in an unloaded state. Chamber 182 is empty. FIG. 5B shows the moment when the force of the controlled explosion is at a maximum. In this state, the gunpowder charge 122 is initiated and hot high pressure gases are pushing the piston 124 away from the face of the charge 122. Piston 124 attaches to connecting rod 125 which attaches to cup 164. Piston 181 is arranged at a lip of cup 164. Piston 181 is seated against spring 162 which is loaded and locked by the locking means 163 in this state. High-pressure chamber 182 is vacuumed and saline water fills the chamber through the inlet 184 and valve 402.

FIG. 5C shows the third phase of the desalinator in action. The locking device 163 is unlocked. The energy accumulating spring 162 pushes against high-pressure piston 181 and in this way presses the salted water through regulator 200 and over RO membrane 302 arranged in chamber 300. The role of the regulator 200, which is hydrodynamic resistance, in this embodiment porous is layers of sintered material, chosen as one of group of limited orifice, thick felt, several layers of fine mesh, screen or grid, layer of particulate or sintered material or combination of the above is used to slow the speed of impure fluids and or saline water stream coming from high-pressure water pump to the surface of filtration module and or RO membrane 302 in the RO chamber 300. Filtration module and or RO membranes are any market available filtration module and/or RO membranes accommodated into the integrated body of the desalinator 100. Output of filtered fluids and/or desalinated water are drained through outlet 310 and by valve 401.

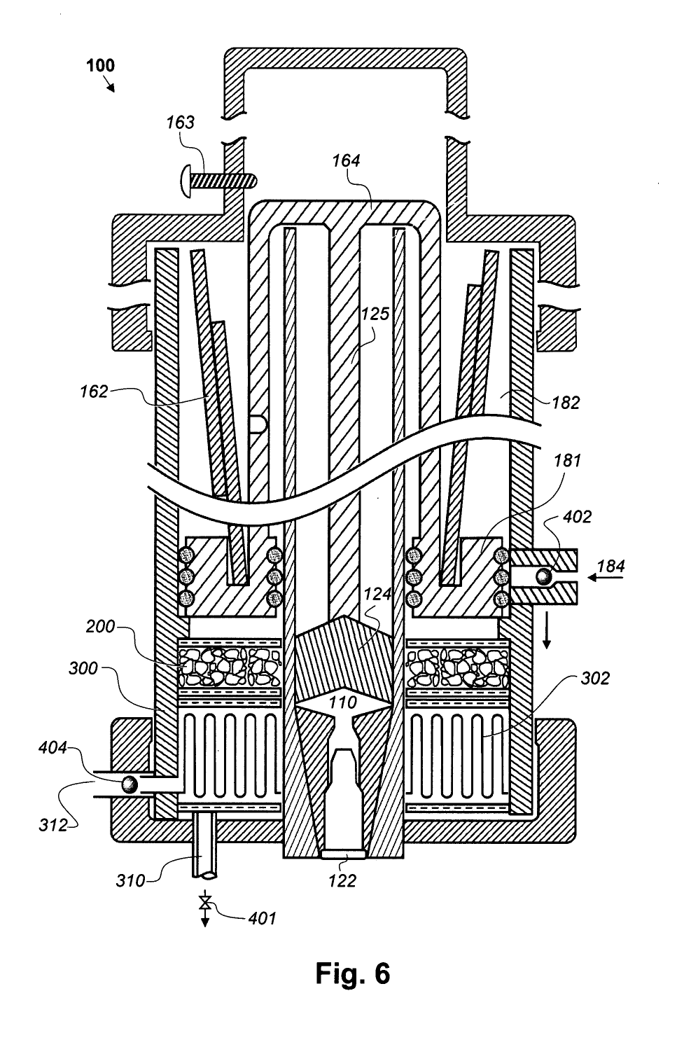

FIG. 6 represents a more detailed schematic diagram of another one embodiment that includes an integrated device based on a gunpowder explosive charge and a telescopic spring acting as an energy accumulator. The hydrodynamic resistance 200 is integrated within a cartridge together with RO membrane 302. After the gunpowder charge 122 is activated, the hot high-pressure gases fill chamber 110 and push forward the explosion chamber piston 124. Piston 124 connects to cup 164 via connecting rod 125. Piston 181 is arranged on a lip of cup 164 and includes a back side having a notch for acting on a front side of the telescopic spring 162. The locking device locks the cocked spring 162 in a fully charged position. High-pressure chamber 182 is vacuumed partially and subsequently filled by the inlet 184. When the cocking device 163 is disengaged, the telescopic spring 162 presses, by piston 181, fluids and/or water in the chamber 182 through the restrictor particulate layer 202 to the RO membrane 302. The purified fluids desalinated water flow is drained by outlet 310 and regulating valve 401. The saline water is expelled by outlet regulating valve 404 and outlet 312. The design shown in FIG. 6 is more applicable to water with low to moderate salinity, and which has a comparably big area of the active cross-section of plunger 181 and relatively high productivity ratio of saline to clean water.

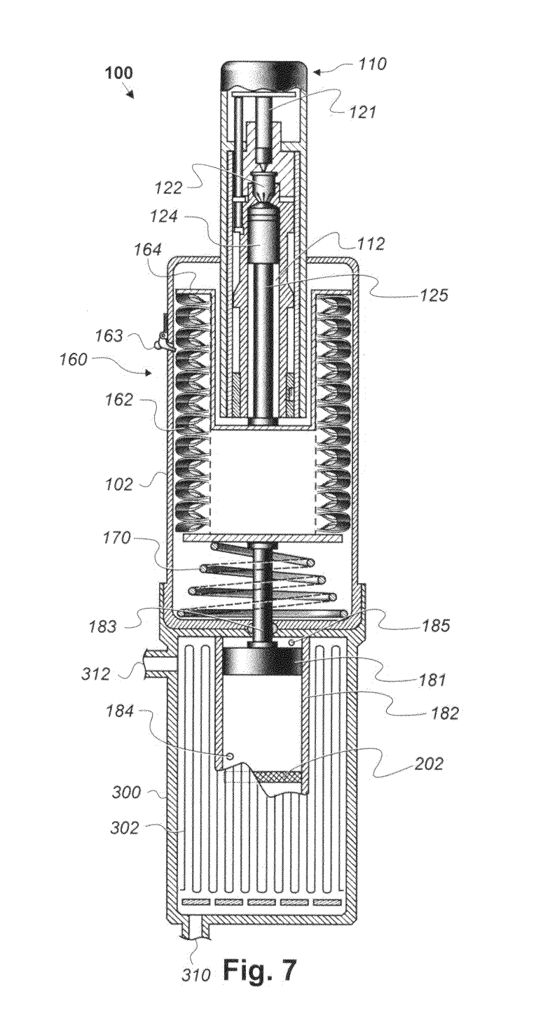

FIG. 7 depicts a desalinating device of the present invention based on a gunpowder load and a crest-to-crest spring acting as an energy accumulator. The device is different from the embodiment shown in FIG. 6. which allows for the use of different hollow spring packages and having a high-pressure chamber combined with a RO chamber. The RO chamber is annular to the high-pressure chamber and has a build-in flow restrictor 202 (having the same function as the generic hydrodynamic resistance 200). During activation of the device, pin assembly 121, strikes the sensitive back of the gunpowder load 122. The gunpowder load explodes and hot high-pressure gases push the powder-propelled plunger 124. The gunpowder load may be bought in a variety of calibers ranging from .22 cal. to .27 cal. under the brand names Hilti® and Ram Shots™. By the piston rod 125 and cup 164, force is loaded onto the accumulating spring 162. The spring remains in a loaded position by locking assembly 163. While one end of the spring is loaded by spring loading cylinder (cup) 164, the other end of the same spring is acting on connecting rod 183 and adjacent high pressure piston 181. The high-pressure piston is pressurizing the saline water over the pressure regulating restrictor 202 (flow regulator). The role of this restrictor is to allow gradual increase of the saline water pressure in a high-pressure chamber 182. This gradual increase is necessary because high-energy impulses applied on one side of the RO membrane 302 can destroy the membrane and the membrane arrangement including separator media (not shown on the figures). Thus, the force of loaded spring is filtrating saline water from chamber 182. On the backside of the high-pressure piston 181, the rejected brine is assisting to provide needed pressure. Quantity and pressure of the assisting brine are function of predetermined ratio of filtration between rejected brine and desalinated water.

Crest-to-crest springs used in this design are known to have much better performance working as compressed springs when compared to cylindrical wire type spiral springs. Their ratio working length to compressed length when compared to wire cylindrical springs is far superior to a wire type cylindrical spring. The same is true for their ratio-accumulated power/weight.

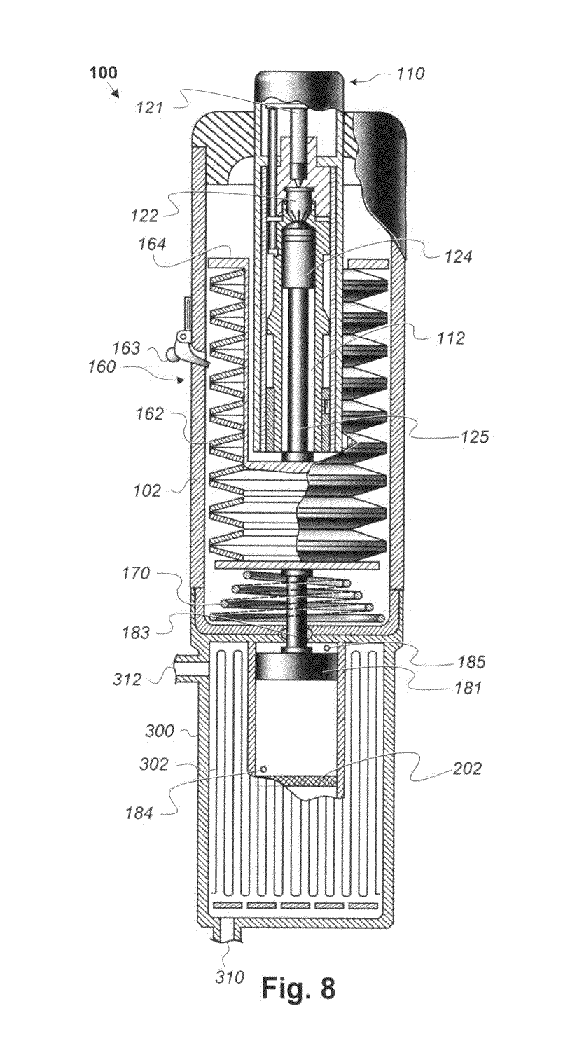

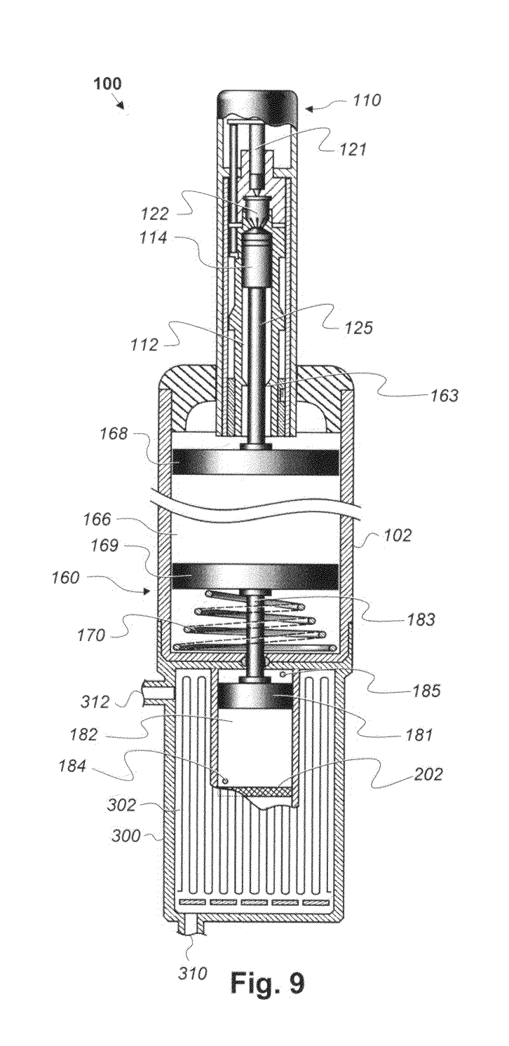

Another embodiment of the present invention is depicted in FIG. 8. All main components of the system are the same, function the same way and are numbered correspondingly with the same numbers. The main difference in this embodiment is the use of another extremely powerful spring package of disc springs known also as Belleville washer type springs. This spring package has some advantages over other springs by accumulating the highest possible power per unit weight. As far as the walls of the body 102 are compensating bigger stretching forces they are thicker than ones shown in the embodiment in FIG. 7.

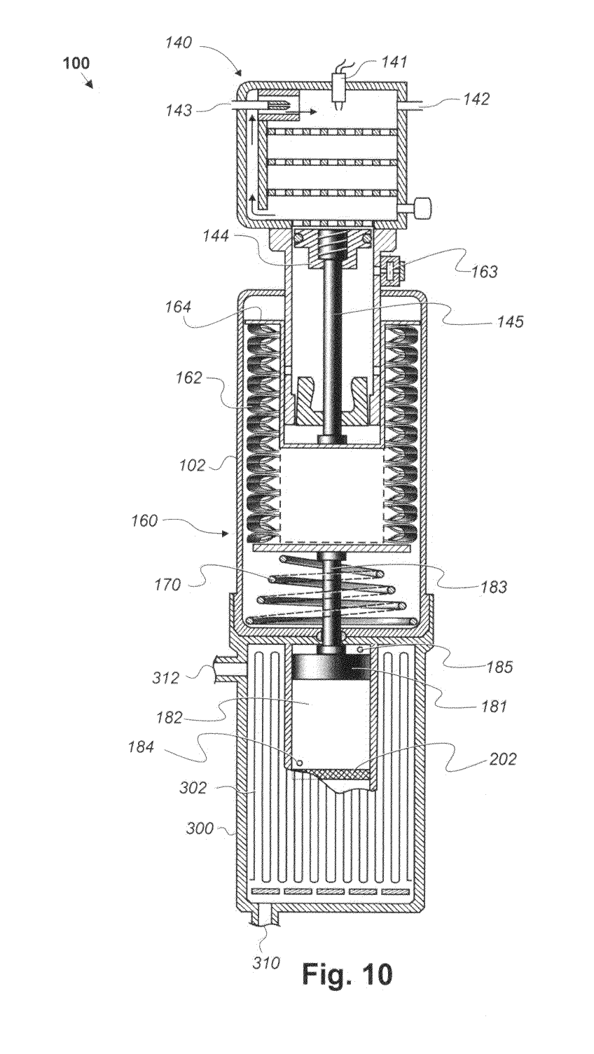

Yet another embodiment of the present invention is explained in FIG. 9. The device is accumulating the gunpowder explosion blast confined in a design depicted already in FIG. 7 and FIG. 8. The power transferring connecting rod 125 is compressing gas or air in the gas-spring 166. The gas-spring 166 is formed between gas compressing piston 168 and gas compressed piston 169 confined in the cylindrical wall of the body 102. The wall of the body is made thicker when compared to the one in the embodiment shown in FIG. 7 in order to accommodate a high air or gas pressure and stretching forces. Compressed gas piston 169 is transferring the energy accumulated in the compressed spring by the blast air or gas further into high-pressure chamber the way already shown and described in FIG. 7 and FIG. 8. Further the embodiment functions the same way as the embodiments shown in FIGS. 7 and 8. According to an objective of the present invention, another embodiment is shown in FIG. 10 and represents a desalinating device using a gas-fuel combustion as an energy source. Chamber 140 is filled with air by inlet 142 and a gas-fuel mixture is injected by inlet 143. After ignition by spark plug 141, the hot high-pressurized gases push the piston 144 which connects to rod 145. Power is transferred from the piston 144 through rod 145 to the spring cup 164 to load spring 162. The energy is locked by locking mechanism 163. Further operations of the mechanism are as those shown in FIGS. 7, 8 and 9.

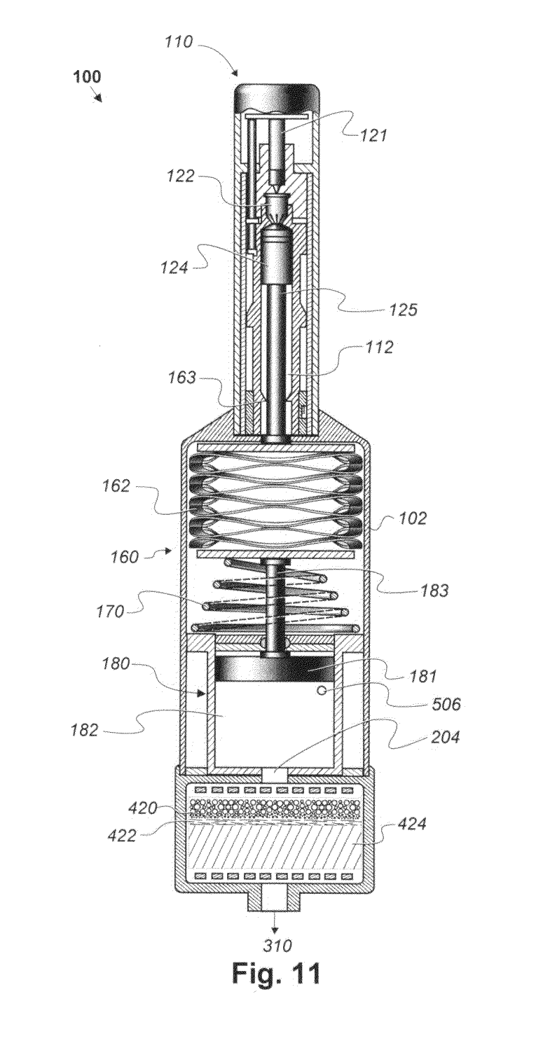

As set forth in the objectives, a powder actuated pump may be used for alternative purposes other than desalination. The embodiment shown in FIG. 11 represents a device for micro-filtration. All main parts such as the powder actuated explosion assembly 110, the energy accumulator 160, the reversing spring 170 and the high pressure pump have the same design and same functions as in those previously described FIG. 7 and FIG. 8. Contaminated fluid is fed by the inlet into a high pressure pump cylindrical chamber 182, pressed by the piston 181 and expelled over the pre-filtration media 420 covering micro-filtration media 422. Filtered fluid is drained by outlet 310.

It is in the spirit of present invention that the blast actuation and energy accumulation can have many different applications. FIG. 11 depicts a device, which functions as a high-pressure pump in micro-filtration device. The filtration elements 420, 422 and 424 along with flow restrictor 204, designed as limited orifice, are integrated into one body with all other described elements.

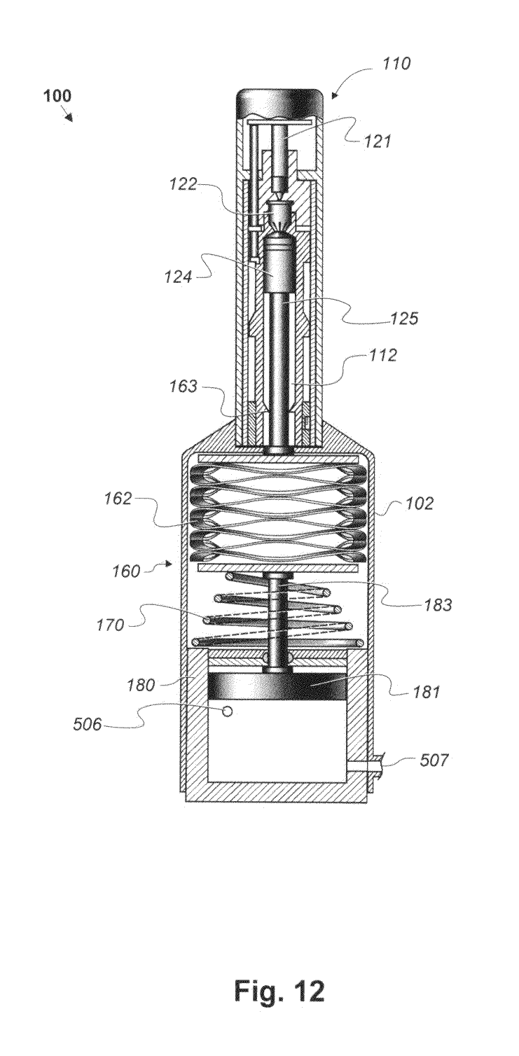

Further, it is in the spirit of present invention that the blast actuation and energy accumulation can have many other different applications, such as high-pressure pump in portable a High Performance Liquid Chromatography (HPLC) unit depicted in FIG. 12. The fluid or solvent is fed by inlet 506 into a high-pressure pump body 180 and expelled by outlet 507. For convenience, the appropriate check valves are not shown. The powder actuation part 110 and energy accumulator 160 are the same design as those shown in FIG. 7 and FIGS. 8, 10, and 11. The main difference is in the high-pressure pump. There is no flow assisting on the backside of the high-pressure piston 181 in this embodiment.

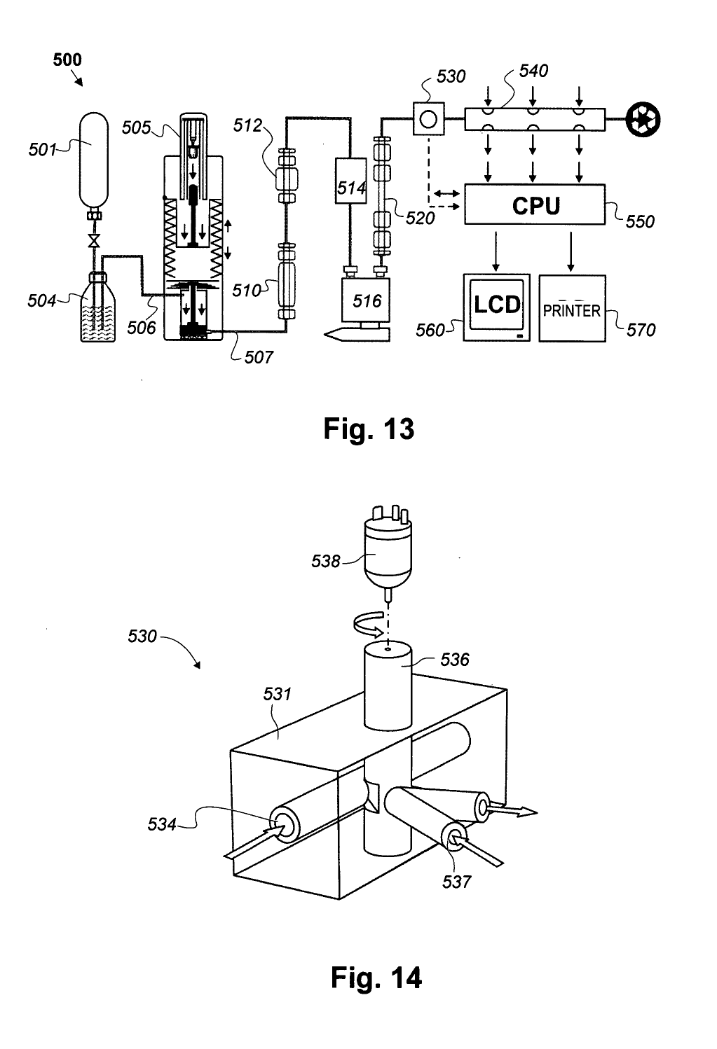

In FIG. 13 the high pressure pump device 100 is shown as part of a HPLC portable system interacting with all other components of the system. All other components of the system as well as the consequence of the elements, except flow indexer 530, are known in the prior art and perform accordingly.

FIG. 14 illustrates a 3 dimensional schematic and function of the flow indexer 530 of FIG. 13. The fluid flow is along the capillary 534 into the indexer body 531 which is made of a hard neutral material. The group preferably comprises sapphire, corundum, quartz, glass, sintered oxides and or carbides, stainless steel. Capillary 534 is crossing into the body slightly interfering the rotating cylinder-indexer 536, which has an indentation in the plane and a place where it meets the capillary. A step motor is rotating or moved by an indexing impulse in predetermined and changeable time intervals. At any rotation, the indentation passes around the nozzle of another capillary 537 going to or touching at the same plane as the rotating cylinder. A very small amount of predetermined volume of fluid is transferred through the indentation and from the capillary 537 to capillary 534 and respectively from capillary 534 to capillary 537. When in the capillary 537 there is a flow of fluid with known very small amount of detectable substance, the flow is indexed with very small peaks identifiable by detector 540 in FIG. 13. If the fluid flow in capillary 534 is fast, the indexes are far from each other, if the fluid flow is slow, the indexes are closer together. When the speed of rotation of indexer is permanent, the flow can be well measured by the indexed peaks and retaining time determined for each component despite of some flow fluctuations. The flow indexer may be included in the desalination process for maintaining a constant pressure across the RO membrane. In this manner, the flow of energy from the energy accumulator may be restricted to allow the accumulated energy to be released over a greater period of time. Moreover, the flow indexer may be included in the flow path and include one or more selected from a group comprising a critical orifice, a limiting orifice, a layer of particulate material, a layer of felt, a stacked mesh-screen assembly, and a stacked fabric assembly.

It should be well understand by one skilled in the art that depicted embodiments have the same main parts an energy blast power source, an energy accumulator, a locking cocking/releasing means, a high pressure pump, an energy restricting element and a power consuming element (energy consuming element). They can be integrated within a main body with different functional portions and interconnected between themselves mechanically and/or fluidly.

One skilled in the art should understand that the main parts could be interconnected in different combinations still achieving the same final effect of transforming the peak energy of the explosion blast to more a convenient form of energy for further use, e.g. potential energy of a loaded spring by the accumulating energy of explosive power blast.

It should be understand that the main goal of present invention is not limited to the directly targeted portable and hand held devices and can be used in much larger proportionally units. It is in the spirit of the present invention to use the blast of energy of any energy impulse-generating source, to accumulate this energy and gradually to release it in the process of energy driven mechanical power consumer.

We claim:

1. A method for accumulating blast energy and converting it into useful energy, said method comprising:
depositing an explosive charge into a detonation chamber;
detonating the explosive charge to generate a high energy blast impulse to drive a first piston;
accumulating energy in an energy accumulating means;
storing said energy in the energy accumulating means by engaging a catch;
releasing stored energy and driving a second piston to increase pressure onto a fluid-to-be-filtered by disengaging the catch;
forcing said fluid-to-be-filtered through a filtration module; and,
draining filtered fluid from within said filtration module.

2. The method of claim 1 wherein said depositing an explosive charge into a detonation chamber includes depositing one or more from a group consisting of gunpowder, a gaseous fuel/air mixture, a gaseous fuel/oxygen mixture, a liquid fuel in air mixture, and a liquid fuel in an oxidant mixture.

3. The method of claim 1 wherein said accumulating energy in an energy accumulating means include accumulating energy in one or more from a group consisting a metal spring, a nonmetallic spring, an air-spring, a gas-spring, and a high pressure gas-spring.

4. The method of claim 1 wherein said releasing the stored energy includes allowing stored energy to be gradually released by means of superimposing on a flow path of the fluid-to-be-filter one or more selected from a group consisting of a critical orifice, a limited orifice, a layer of particulate material, a layer of felt, a stacked mesh-screen assembly, and a stacked fabric assembly.

5. The method of claim 1 wherein said detonating the explosive charge to generate a high energy blast impulse to drive a first piston further includes drawing a fluid-to-be-filtered into the filtration module.

6. The method of claim 1 wherein said forcing the fluid-to-be-filtered through a filtration module includes forcing saline water through a reverse osmosis filter.

7. The method of claim 1 further including delaying the release of energy from the energy accumulating means by restricting flow of fluids into the filtration module.

8. The method of claim 7 wherein delaying the release of energy from the energy accumulating means includes indexing an indentation to move fluid between capillaries.

9. The method of claim 1 further including separating the feed fluid into a permeate fluid fraction which passes through the filter membrane, and a concentrated fluid fraction which is returned from the filter membrane to an expanded part of a pumping chamber to recover fluid pressure for pressurizing the fluid-to-be-filtered.

10. A method for desalination by reverse osmosis comprising the steps of:
generating energy by a short duration high pressure blast impulse created by detonating explosive matter;
accumulating the generated energy in an energy storage means;
catching the energy accumulator in a fixed position;
activating the energy accumulator to release stored energy;
high pressure pumping by pressurizing a feed fluid in a pumping chamber by a compression stroke of a piston means which forces pressurized feed fluid through a filter membrane, and admitting a concentrated fluid fraction from an unfiltered side of the filter membrane into an expansion chamber to supplement energy supplied to the piston during the compression stroke of the piston means by using pressure of the concentrated fluid to perform reverse osmosis filtration; and,
delaying the release of energy from the energy accumulator by generating impulse time periods by closing and opening a flow restrictor arranged on a flow path through which fluid-to-be-filtered is moved.

11. The method of claim 10 further including recuperating energy by reversing a direction of force applied to the piston means and simultaneously hydraulically biasing the piston means against movement to transmit said force to a valve means causing the valve means to shift relative to movement of the piston means to mechanically shift the valve means to direct fluid flow between the pump means and the membrane means, the transfer of reaction forces causing a dwell period so that the valve means shifts across a closed intermediate position thereof during an interval of substantially zero fluid transfer in an expansion chamber thus incurring timely valve shifting.

12. A micro-filtration system comprising:
means for generating energy in an explosive manner;
an energy accumulator for storing said energy;
a catch for engaging said energy accumulator to maintain stored energy therein;
means for slowly releasing the stored energy from the energy accumulator;
means for restricting fluid flow;
means for high pressure pumping of a fluid through said means for restricting fluid flow;
means for pre-filtration of the fluid arranged in a supply line that is connected to the means for high pressure pumping; and,
means for micro-filtration of the fluid arranged downstream from the means for high pressure pumping.

13. A chromatographic system comprising:
a detonation chamber;
an explosive charge loaded into said detonation chamber;
a mechanical means propelled by a detonation of said explosive charge to transfer energy created from said detonation into a single direction of movement;
an energy accumulator that stores energy created by movement of the mechanical means;
a filtration module through which said energy accumulator pushes fluids to be filtered;
an inlet for drawing in fluids to be filtered arranged in said filtration module;
a first outlet for draining filtered fluids from within the filtration module; and,
a second outlet for draining fluids that have elevated concentrations of impurities that have been removed from the filtered fluids.

14. The chromatographic system of claim 13 further comprising:
a flow indexer comprising a solid body and two capillaries interconnected by a rotating cylinder having small indentations in a plane where both of the capillaries are closed and transferring fluid from one capillary to another with a frequency proportional to steps by which a step motor is rotating said rotating cylinder.

15. The chromatographic system of claim 14 wherein a speed of the step motor and a frequency of indexing of the rotating cylinder are predetermined from electronic means and the frequency of indexing relates to peaks generated by a detector to allow commutating a retention time of certain substances when a condition of fluctuating flow exists.

16. A fluid purifier system comprising:
a detonation chamber;
an explosive charge loaded into said detonation chamber;
a mechanical means propelled by a detonation of said explosive charge to transfer energy created from said detonation into a single direction of movement;
an energy accumulator that stores energy created by movement of the mechanical means to be released,
a filtration module through which said energy accumulator pushes fluids to be filtered;
an inlet for drawing in fluids to be filtered arranged in said filtration module;
a first outlet for draining filtered fluids from within the filtration module; and,
a second outlet for draining fluids that have elevated concentrations of impurities that have been removed from the filtered fluids.

17. The fluid purification system of claim 16 wherein said explosive charge includes one or more selected from a group consisting of gunpowder, a gas fuel/air mixture, a gas fuel/oxygen mixture, a liquid fuel in air mixture, and a liquid fuel in oxidant mixture.

18. The fluid purification system of claim 16 wherein said energy accumulator is selected from a group consisting of a metal spring, a nonmetallic spring, an air-spring, a gas-spring, and a high pressure gas-spring.

19. A reverse osmosis apparatus comprising:
means for generating energy in an explosive manner;
means accumulating the energy;
means for cocking the energy accumulator;
means for slowly releasing the energy from the energy accumulator;
means for restricting a fluid flow through the reverse osmosis apparatus;
means for high pressure pumping; and,
a reverse osmosis filtering means.

20. The reverse osmosis apparatus of claim 19 wherein the reverse osmosis apparatus comprises:
a chamber for containing energy created from an explosion, said explosion being created from an explosive selected from a group consisting of gunpowder, a gas-fuel; propane, butane, pentane, atomized liquid fuel comprising light fractions of gasoline; and a mixture thereof;
a piston having a stem that transfers an energy impulse mechanically to other part of the reverse osmosis apparatus;
means for initiating the explosion; and,
means for primary supply of energy generating compound.

21. The reverse osmosis apparatus of claim 19 wherein the means for accumulating the energy generated as a result of the explosion is selected from a group consisting of a metal spring, a nonmetallic spring, and a gas-spring.
